(19) United States
(12) Patent Application Publication
(10) Pub. No.: US 2026/0144271 A1
(43) Pub. Date: May 28, 2026

(54) PROCESS FOR PREPARING A COFFEE PRODUCT

(71) Applicant: Koninklijke Douwe Egberts B.V., Utrecht (NL)

(72) Inventors: Casper Horn, Utrecht (NL); Borja Roman Corrochano, Utrecht (NL); Amir Asghari, Utrecht (NL); Javier Silanes Kenny, Utrecht (NL); Georgia Katsi, Utrecht (NL)

(21) Appl. No.: 19/122,677

(22) PCT Filed: Oct. 18, 2023
(86) PCT No.: PCT/EP2023/079061

§ 371 Date: Apr. 18, 2025

(30) Foreign Application Priority Data
Oct. 20, 2022 (GB) 2215518.8

(51) Int. Cl. A23F 5/14; A23F 5/38; A23F 5/40; B65D 85/804

(52) U.S. Cl. CPC A23F 5/14; A23F 5/385; A23F 5/405; B65D 85/8043

(57) ABSTRACT

The present invention relates to a process for manufacturing a coffee product comprising the steps of: a) spraying a liquid instant coffee onto roast and ground coffee particles to coat the roast and ground coffee particles with instant coffee; b) mixing the mixture formed in step a); c) densifying the coated roast and ground coffee particles; and d) drying the coated roast and ground coffee particles to form a coffee product comprising roast and ground coffee particles coated with instant coffee. The present invention also relates to a coffee product comprising roast and ground coffee particles coated with instant coffee.

### TECHNICAL FIELD OF THE INVENTION

The present invention relates to a process for manufacturing a coffee product. In particular, the present invention relates to a process for manufacturing a coffee product comprising coating roast and ground coffee particles with instant coffee and densifying the coated roast and ground coffee particles.

### BACKGROUND TO THE INVENTION

Hermetic sealed capsules containing roast and ground coffee for placement in a coffee preparation machine are known in the art. Such capsules are mostly arranged and used to extract coffee by pressing an infusion fluid such as hot water under pressure into a bed of roast and ground coffee beans.

The capsules are generally provided with enough ground roast coffee to provide a specific brew size. Typically, each capsule must have a specific size and shape to fit the coffee preparation machine(s) for which they are designed.

In some cases, when making larger brew sizes the capsules are unable to provide a sufficient amount of total dissolved solids in the resulting brewed coffee for the taste of some consumers.

One way in which it is known to increase the total amount of dissolved solids in the brewed coffee is to increase the total amount of roast and ground coffee particles in the capsules. However, since the capsules are limited in size and volume, it is sometimes not possible to fit additional amounts of roast and ground coffee particles into the capsule in order to provide the requisite amount of total dissolved solids for a desired taste in larger brews.

Alternatively, it is also known to replace the roast and ground coffee particles in the capsules with instant coffee or liquid coffee extract in order to increase the amount of total dissolved solids. However, it has been found that this results in the brew having a distinctive instant coffee flavour. For some consumers a less instant coffee flavour is preferable.

Alternatively still, it is known to use a mixture of roast and ground coffee particles and instant coffee particles in the capsule in order to increase the amount of total dissolved solids in the brewed coffee. However, simply mixing roast and ground coffee particles and instant coffee together and putting the mixture into a capsule, results in blocking of the capsule during brewing.

Additionally, it is known from at least U.S. Pat. No. 3,713,842A, DE2811353A1, WO2018/115402A1, WO2017/211987A1 and EP2233013 to produce roast and ground coffee particles coated with instant coffee. However, these processes typically result in the production of a coffee product having high level of fines, low density, low solubility, and low amounts of brew solids in the resulting beverage.

As a result, it is an aim of the present invention to provide an improved process for manufacturing a coffee product for use in a container, such as a capsule.

It is a further aim of the present invention to provide a process for producing a coffee product that is able to form a brew having a higher total dissolved solids amount whilst still maintaining a roast and ground coffee flavour.

It is a further aim of the present invention to provide an improved process for manufacturing a coffee product involving mixing a roast and ground coffee with instant coffee without the resulting coffee product causing blocking of the container and/or having a reduced or no instant coffee flavour.

It also an aim of embodiments of the present invention to provide an improved coffee product having reduced level of fines, increased density, improved solubility and/or increased amount of brew solids in the resulting beverage.

It is also an aim of embodiments of the invention to overcome at least one problem of the prior art, whether expressly disclosed herein or not.

### SUMMARY OF THE INVENTION

According to a first aspect of the present invention, there is provided a process for manufacturing a coffee product comprising the steps of:
a) spraying a liquid instant coffee onto roast and ground coffee particles to coat the roast and ground coffee particles with instant coffee;
b) mixing the mixture formed in step a);
c) densifying the coated roast and ground coffee particles; and
d) drying the coated roast and ground coffee particles to form a coffee product comprising roast and ground coffee particles coated with instant coffee particles.

Steps a) and b) may be carried out simultaneously.

In some embodiments, steps a), b) and c) may be carried out simultaneously.

Alternatively, steps a), b) and c) may be carried out sequentially.

The inventors found that by carrying out a process according to the first aspect of the invention they were able to provide roast and ground coffee particles coated with instant coffee.

Beneficially, the inventors found that the coated roast and ground coffee particles were able to provide a higher amount of total dissolved solids in a brewed coffee when compared to the same weight of roast and ground coffee particles alone.

Moreover, surprisingly, the inventors observed that the coated roast and ground coffee particles did not cause any blocking when used in a container, such as a capsule, in a coffee preparation machine. Without being bound by theory, this is thought to be due to the instant coffee particles being attached and better distributed over the surface of the roast and ground coffee particles, preventing any potential mobile partially dissolved instant lumps from forming and blocking water channels in the roast and ground coffee.

In addition, the densification of the coated ground coffee particles forms less friable and more dense agglomerates of coated roast and ground coffee particles. These less friable and/or more dense agglomerates are less likely to break up, thereby preventing the broken smaller agglomerates from entering and blocking the water channels. Moreover, the increased density allows for greater fill volumes in existing capsules.

The term “instant coffee particles” refers to soluble coffee extract particles, from which coffee in the form of a liquid drink can be made by reconstitution with hot water.

The term “liquid instant coffee” refers to a solution prepared by mixing instant coffee particles and water, and/or a liquid instant coffee concentrate.

In some embodiments, the liquid instant coffee concentrate may have a total content of soluble solids of at least 20 wt. %, 30 wt. %, 40 wt. %, 45 wt. %, or 50 wt. % by weight of the liquid instant coffee concentrate. The liquid instant coffee concentrate may have a total content of soluble solids of no more than 75 wt. %, 70 wt. %, 65 wt. %, 60 wt. %, 55 wt. % or 50 wt. % by weight of the liquid instant coffee concentrate.

In some embodiments, the liquid instant coffee concentrate may have a total content of soluble solids of between 20 and 75 wt. %, 30 and 70 wt. %, 40 and 65 wt. % or 40 and 55 wt. % by weight of the liquid instant coffee concentrate. The step of spraying the liquid instant coffee may comprise spraying liquid instant coffee in an amount of at least 1 wt. %, 2 wt. %, 3 wt. %, 4 wt. %, 5 wt. %, 6 wt. %, 7 wt. %, 8 wt. %, 9 wt. %, 10 wt. %, 11, 12 wt. %, 13 wt. %, 14 wt. %, 15 wt. %, or at least 20 wt. % by weight of the coffee product. The step of spraying the liquid instant coffee may comprise spraying liquid instant coffee in an amount of no more than 20 wt. %, 15 wt. %, or no more than 10 wt. % by weight of the coffee product.

The step of spraying the liquid instant coffee may comprise spraying liquid instant coffee in an amount of from 1-20 wt. %, 1-15 wt. %, 1-10 wt. %, 1-9 wt. %, 1-8 wt. %, 1-6 wt. %, 1-7 wt. %, 1-6 wt. %, or from 1-5 wt. % by weight of the coffee product.

The coffee product may comprise roast and ground coffee in an amount of at least 50 wt. %, 55 wt. %, 60 wt. %, 65 wt. %, 70 wt. %, 75 wt. %, 80 wt. %, 85 wt. %, or at least 90 wt. % by weight of the coffee product. The coffee product may comprise roast and ground coffee in an amount of no more than 99 wt. %, 98 wt. %, 97 wt. %, 96 wt. %, 95 wt. %, 94 wt. %, 93 wt. %, 92 wt. %, 91 wt. %, 90 wt. %, 85 wt. %, 80 wt. %, 75 wt. % or no more than 70 wt. % by weight of the coffee product. The coffee product may comprise roast and ground coffee in an amount of from 75-99 wt. %, 75-99 wt. %, 80-99 wt. %, 85-99 wt. %, 70-95 wt. %, 70-90 wt. %, 70-85 wt. %, 70-80 wt. %, 75-95 wt. %, 75-90 wt. %, 75-80 wt. % 90-99 wt. %, 80-95 wt. %, or 85-95 wt. %, by weight of the coffee product.

In some embodiments, the roast and ground coffee may be derived from pure Arabica whole coffee beans.

In some embodiments, the roast and ground coffee may be derived from pure Robusta whole coffee beans.

In other embodiments, the roast and ground coffee may be derived from a mixture of Arabica and Robusta whole coffee beans.

In some embodiments, the pressure under which the spray of liquid instant coffee droplets is formed in step a) is at least 1 bar, 2 bar, 3 bar, 4 bar, 5 bar, 6 bar, 7 bar, 8 bar, 9 bar or 10 bar. In some embodiments the pressure under which the spray of liquid instant coffee droplets is formed in step a) is between 1 to 10 bar, 1 to 5 bar, preferably between 2 to 5 bar.

In some embodiments, the liquid instant coffee may have a viscosity of at least 5 mPas, 10 mPas, 15 mPas, 20 mPas or 25 mPas. The liquid instant coffee may have a viscosity of no more than 35 mPas, 30 mPas, 25 mPas, 20 mPas.

The liquid instant coffee may have a viscosity of 5-35 mPas, 5-30 mPas, 10-30 mPas, 15-30 mPas, 20-30 mPas, 10-25 mPas or 10-20 mPas.

Step a) of spraying the liquid instant coffee may have a time of at least 3 minutes, 4, minutes, 5 minutes, 6 minutes, 7 minutes or 8 minutes. In some embodiments, step a) may have a time of no more than 12 minutes, 11 minutes, 10 minutes, 9 minutes or 8 minutes.

Step a) may have a time of 3-12 minutes, 4-11 minutes, 5-10 minutes, 6-10 minutes, 7-10 minutes, 8-10 minutes, 5-9 minutes, 5-8 minutes or 5-7 minutes. Embodiments with such parameters have the additional advantage of low level of fines in the coffee product. Moreover, the inventors also discovered that the preferred parameters reduced brew times of the resultant product to below 180 seconds.

The mixture formed in step a) may be mixed in step b) for a period of at least 50 seconds, 60 seconds, 70 seconds, 80 seconds, 90 seconds, 100 seconds, 110 seconds, 120 seconds, 130 seconds 140 seconds 150 seconds, 160 seconds, 170 seconds, 180 seconds, 200 seconds, 225 seconds, 250 seconds, 275 seconds, 300 seconds, 325 seconds, 350 seconds, 375 seconds, 400 seconds, 425 seconds, 450 seconds, 475 seconds, 500 seconds, 525 seconds, 550 seconds, 575 seconds, or 600 seconds.

It has been observed that such mixing times enables the roast and ground coffee particles to have a more uniform coating of instant coffee. This reduces the chance of the coffee product blocking a container, filter or outlet during brewing.

Step b) may have a tip speed of at least 0.5, 0.6, 0.7, 0.8, 0.9, 1.0, 1.1, 1.2, 1.3, 1.4, 1.5, 1.6, 1.7, 1.8, 2.0 m/s, 2.2, 2.4 or 2.5 m/s. In some embodiments, step b) may have a tip speed of no more than 5.0, 4.8, 4.6, 4.4, 4.2, 4.0, 3.8, 3.6, 3.4, 3.2, 3.0, 2.8, 2.6, 2.4, 2.2 or 2.0 m/s.

Step b) may have a tip speed of 0.5-5 m/s, 0.5-4 m/s, 0.5-3 m/s, 0.5-2.5 m/s, 0.5-2.0 m/s, 1.0-2.0 m/s, 1.2-2 m/s, 1.4-2.0 m/s or 1.5-2.0 m/s. It has been observed that such mixing speeds increases the density of the coffee product. This reduces the chance of the coffee product blocking a container during brewing and increases the fill weight of the coffee product.

The step of densifying the coated roast and ground coffee particles may comprise increasing the density of the roast and ground coffee particles.

The step of densifying the coated roast and ground coffee particles may comprise increasing the density of the coated roast and ground coffee particles to at least 250, 300, 350 g/l or 400 g/l and/or no more than 850, 650 or 600 g/l and/or between 250-850 g/l; 35-850 g/l; 250-600 g/l or 350-600 g/l.

In some embodiments, the step of densifying the coated roast and ground coffee particles may comprise increasing the density of the coated roast and ground coffee particles to at least 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, or 400 g/l.

In some embodiments, the step of densifying the coated roast and ground coffee particles may comprise increasing the density of the coated roast and ground coffee particles to no more than 900, 895, 890, 885, 880, 875, 870, 865, 860, 855, 850, 845, 840, 835, 830, 825, 820, 815, 810, 805, 800, 795, 790, 785, 780, 775, 770, 765, 760, 755, 750, 745, 740, 735, 730, 725, 720, 715, 710, 705, 700, 695, 690, 685, 680, 675, 670, 665, 660, 655, 650, 645, 640, 635, 630, 625, 620, 615, 610, 605, 600, 595, 590, 585, 580, 575, 570, 565, 560, 555, 550, 545, 540, 535, 530, 525, 520, 515, 510, 505, 500, 495, 490, 485, 480, 475, 470, 465, 460, 455, 450, 445, 440, 435, 430, 425, 420, 415, 410, 405, or no more than 400 g/l.

In some embodiments, the step of densifying the coated roast and ground coffee particles may comprise increasing the density of the coated roast and ground coffee particles to from 250-850, 350-850, 250-600 g/l, 350-600, 200-600, 205-595, 210-590, 215-585, 220-580, 225-575, 230-570, 235-565, 240-560, 245-555, 250-550, 255-545, 260-540, 265-535, 270-530, 275-525, 280-520, 285-515, 290-510, 295-505, 300-500, 300-495, 300-490, 300-485, 300-480, 300-475, 300-470, 300-465, 300-460, 300-455, 300-450, 300-445, 300-440, 300-435, 300-430, 300-425, 300-420, 300-415, 300-410, 300-405, 350-550, 360-540, 370-530, 380-520, 390-510, 400-500, 400-500, 400-490, 400-480, 400-470, 400-460, 400-450, 400-440, 400-430, 300-400, 305-400, 310-400, 315-400, 320-400, 325-400, 330-400, 300-395, 300-390, 300-385, 300-380, 300-375, 300-370, 305-395, 310-390, 315-385, 320-380, 325-375, or from 330-370 g/l.

The step of densifying the coated roast and ground coffee particles may comprise subjecting the coated roast and ground coffee particles to shear mixing.

The shear mixing may be high shear mixing and/or low shear mixing. The step c) of densifying the coated ground coffee particles may be carried out for at least at least 50 seconds, 60 seconds, 70 seconds, 80 seconds, 90 seconds, 100 seconds, 110 seconds, 120 seconds, 130 seconds 140 seconds 150 seconds, 160 seconds, 170 seconds, or 180 seconds, 200 seconds, 250 seconds, 300 seconds, 350 seconds, 350 seconds, 400 seconds, 450 seconds, 500 seconds or at least 550 seconds.

The process may further comprise a step of filling a mixing device with roast and ground coffee particles.

The step of filling the mixing device may be performed before step a).

The step of filling the mixing device may comprise filling the mixing device to at least 10%, 20%, 30%, 40%, 45%, 50%, 55%, 60%, 65% 70%, 75% 80, or 90% of its total volume. The step of filling the mixing device may comprise filling the mixing device to no more than 90%, 80%, 70%, 65%, 60%, 55%, 50%, 45%, 40%, or 30% of its total volume.

In some embodiments, the step of filling the mixing device may comprise filling the mixing device to 10-90%, 20-80%, 30-70%, 40-70%, 45-70%, 45-65%, 45-60%, 45-55%, 50-60%, 45-60%, 46-60%, 47-60%, 48-60%, 49-60%, 50-60%, 51-60%, 52-60%, 53-60%, 54-60%, 54-60%, 50-59%, 50-58%, 50-57%, 50-56%, or 50-55% of its total volume.

The inventors discovered that if the mixing device is not filled to its total volume, the step of densifying the coated roast and ground coffee particles may result in fluidised particle motion. This may result in the formation of a mechanically induced fluidised bed.

Beneficially, the partial filling of the mixing device allows improved control of the density of the final product. For example, partial filling of the mixing device may provide a lower density product, whereas the complete filling of the mixing device may provide a higher density product.

Therefore, in this embodiment, the step c) of densifying the one or more coated roast and ground coffee particles may comprise mechanically fluidising a bed of the coated roast and ground coffee particles.

The mixing device may be a granulator.

Preferably, the mixing device may be a high shear granulator or a low shear granulator.

Preferably, the mixing device is a high shear granulator.

Beneficially, a granulator is able to carry out at least steps a) to c) and preferably all of the process steps a) to d) in one device. Moreover, a high shear granulator has been found to provide a coffee product with an appropriate friability and density.

The process may further comprise the step of spraying a binding liquid onto the roast and ground coffee particles.

The step of spraying the binding liquid may be carried out before step a).

The step of spraying the binding liquid may be carried out before step b).

Preferably, the step of spraying the binding liquid is carried out after step a) and before step b).

The binding liquid may be an aqueous medium. The aqueous medium may be water or a sugar solution.

The sugar solution may be an aqueous solution comprising a monosaccharide, disaccharide and/or an oligosaccharide. Preferably, the sugar solution may be an aqueous solution comprising glucose, sucrose, fructose, galactose, lactose and/or maltose. In one embodiment, the roast and ground coffee particles in step a) may comprise a dry mixture of solid instant coffee particles and roast and ground coffee particles.

The dry mixture may comprise roast and ground coffee particles in an amount of at least 30 wt. %, 35 wt. %, 40 wt. %, 45 wt. %, 50 wt. %, 55 wt. %, 60 wt. %, 65 wt. % 70 wt. %, 75 wt. %, 80 wt. %, 85 wt. %, 90 wt. %, 91 wt. % 92 wt. %, 93 wt. %, 94 wt. %, 95 wt. %, 96 wt. %, 97 wt. %, 98 wt. % or at least 99 wt. % by weight of the mixture.

The dry mixture may comprise roast and ground coffee in an amount of from 1-99 wt. %, 1-95 wt. %, 1-90 wt. %, 1-85 wt. %, 70-99 wt. %, 75-99 wt. %, 80-99 wt. %, 85-99 wt. %, 70-95 wt. %, 70-90 wt. %, 70-85 wt. %, 70-80 wt. %, 75-99 wt. %, 75-95 wt. %, 75-90 wt. %, 75-80 wt. %, 80-98 wt. %, 80-95 wt. %, 85-95 wt. %, or 90-98 wt. % by weight of the dry mixture.

The dry mixture may comprise solid instant coffee particles in an amount of at least 1 wt. %, 2 wt. %, 3 wt. %, 4 wt. %, 5 wt. %, 6 wt. %, 7 wt. %, 8 wt. %, 9 wt. %, 10 wt. %, 11, 12 wt. %, 13 wt. %, 14 wt. %, 15 wt. %, 20 wt. %, 25 wt. %, 30 wt. %, 35 wt. %, 40 wt. %, 45 wt. % or at least 50 wt. % by weight of the dry mixture. The dry mixture may comprise solid instant coffee particles in an amount of no more than 60 wt. %, 55 wt. %, 50 wt. %, 45 wt. %, 40 wt. %, 35 wt. %, 30 wt. %, 25 wt. %, 20 wt. %, 15 wt. % or no more than 10 wt. % by weight of the dry mixture.

The dry mixture may comprise solid instant coffee particles in an amount of from 1-50 wt. %, 1-45 wt. %, 1-40 wt. %, 1-35 wt. %, 1-30 wt. %, 1-25 wt. %, 1-20 wt. %, 1-20 wt. %, 1-19 wt. %, 1-18 wt. %, 1-17 wt. %, 1-16 wt. % 1-1-15 wt. %, 1-10 wt. %, 1-9 wt. %, 1-8 wt. %, 1-7 wt. %, 1-6 wt. %, 1-5 wt. %, 1-20 wt. %, 1-35 wt. %, 1-30 wt. %, 1-25 wt. %, 5-35 wt. %, 5-30 wt. %, 5-25 wt. %, 10-35 wt. %, 10-30 wt. %, 10-25 wt. %, 10-20 wt. %, 5-20 wt. %, 5-15 wt. %, or 5-10 wt. % by weight of the dry mixture.

The weight ratio of roast and ground coffee particles to solid instant coffee particles in the dry mixture may be at least 1:5, 1:4, 1:3, 1:2, 1:1, 2:1, 3:1, 4:1, 5:1, 6:1, 7:1, 8:1, 9:1 or 10:1.

The weight ratio of solid instant coffee particles in the dry mixture and liquid instant coffee sprayed onto the mixture in step a) may be at least 1:5, 1:4, 1:3, 1:2, 1:1, 2:1, 3:1, 4:1, or 5:1.

Preferably, the weight ratio of solid instant coffee particles in the dry mixture and liquid instant coffee sprayed onto the mixture in step a) is 1:1

The one or more roast and ground coffee particles of the coffee product may have a surface covered by at least 50%, 55%, 60%, 65%, 70%, 75%, 80%, 85%, 90%, or 99% instant coffee.

Preferably, 100% of the surface of the one or more coated roast and ground coffee particles is covered with instant coffee.

The one or more coated ground coffee particles may have a coating of instant coffee with a mean thickness of at least 0.1 micron, 0.5 microns, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64 or 65 microns.

The coated ground coffee particles may have a coating of instant coffee particles with a mean thickness of no more than 250, 245, 240, 235, 230, 225, 220, 215, 210, 205, 200, 195, 190, 185, 180, 175, 170, 165, 160, 155, 150, 145, 140, 135, 130, 125 120, 115, 110, 105, 100, 95, 90, 85, 80, 75, 70, 65, 60, 55 or 50 microns.

In some embodiments, the coated ground coffee particles may have a coating of instant coffee particles with a mean thickness 1 microns to 250 microns, 5 microns to 200 microns, 10 microns to 150 microns, 10 microns to 125 microns, 10 microns to 100 microns, 10 microns to 75 microns, 15 microns to 75 microns, 20 microns to 70 microns, 25 microns to 65 microns, 30 microns to 60 microns, 35 microns to 60 microns or 40 microns to 55 microns. Preferably, the thickness of the coating of instant coffee is uniform over the surface of the roast and ground coffee particles.

The coffee product may have a mean density of at least 250, 300, 350 g/l or 400 g/l and/or no more than 850, 650 or 600 g/l and/or between 250-850 g/l; 35-850 g/l; 250-600 g/l or 350-600 g/l.

In some embodiments, the coffee product may have a mean density of at least 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, or 400 g/l.

The coffee product may have a mean density of no more than 900, 895, 890, 885, 880, 875, 870, 865, 860, 855, 850, 845, 840, 835, 830, 825, 820, 815, 810, 805, 800, 795, 790, 785, 780, 775, 770, 765, 760, 755, 750, 745, 740, 735, 730, 725, 720, 715, 710, 705, 700, 695, 690, 685, 680, 675, 670, 665, 660, 655, 650, 645, 640, 635, 630, 625, 620, 615, 610, 605, 600, 595, 590, 585, 580, 575, 570, 565, 560, 555, 550, 545, 540, 535, 530, 525, 520, 515, 510, 505, 500, 495, 490, 485, 480, 475, 470, 465, 460, 455, 450, 445, 440, 435, 430, 425, 420, 415, 410, 405, or no more than 400 g/l.

The coffee product may have a mean density of from 250-850, 350-850, 250-600 g/l, 350-600, 200-600, 205-595, 210-590, 215-585, 220-580, 225-575, 230-570, 235-565, 240-560, 245-555, 250-550, 255-545, 260-540, 265-535, 270-530, 275-525, 280-520, 285-515, 290-510, 295-505, 300-500, 300-495, 300-490, 300-485, 300-480, 300-475, 300-470, 300-465, 300-460, 300-455, 300-450, 300-445, 300-440, 300-435, 300-430, 300-425, 300-420, 300-415, 300-410, 300-405, 350-550, 360-540, 370-530, 380-520, 390-510, 400-500, 400-500, 400-490, 400-480, 400-470, 400-460, 400-450, 400-440, 400-430, 300-400, 305-400, 310-400, 315-400, 320-400, 325-400, 330-400, 300-395, 300-390, 300-385, 300-380, 300-375, 300-370, 305-395, 310-390, 315-385, 320-380, 325-375, or from 330-370 g/l.

Densities within these limits provide the additional advantage of optimised pack density within the confines of a container, such as a capsule.

The coffee product may have a median or mean particle size of at least 200, 210, 220, 225, 230, 240, 250, 260, 270, 275, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, or at least 600 microns.

The coffee product may have a median or mean particle size of no more than 1000, 980, 970, 960, 950, 940, 930, 920, 910, 900, 890, 880, 870, 860, 850, 840, 830, 820, 810, 800, 790, 780, 770, 760, 750, 740, 730, 720, 710, 700, 690, 680, 670, 660, 650, 640, 630, 620, 610, 600, 590, 580, 570, 560, 550, 540, 530, 520, 510, 500, 490, 480, 470, 460, 450, 440, 430, 420, 410, or no more than 400 microns.

The coffee product may have a median or mean particle size of from 200-600, 200-1000, 200-990, 200-980, 200-970, 200-960, 200-950, 200-940, 200-930, 200-920, 200-910, 200-900, 200-890, 200-880, 200-870, 200-860, 200-850, 200-840, 200-830, 200-820, 200-810, 200-800, 210-790, 220-780, 230-770, 240-760, 250-750, 260-740, 270-730, 280-720, 290-710, 300-700, 310-690, 320-680, 330-670, 340-660, 350-650, 360-640, 370-630, 380-620, 390-610, 400-600, 400-590, 400-580, 400-570, 400-560, 400-550, 400-540, 400-530, 400-520, 400-510, 400-500, 400-490, 400-480, 400-470, 400-460, 400-450, 400-500, 405-490, 410-480, 415-470, 420-460, 425-450, or from 430-440 microns. Median particle size may be measured by laser diffraction method (e.g. Helos/KR (Sympatec) system measured with R7 lens).

The coffee product may have an amount of fine particles (“fines”, particles less than 90 microns, sometimes described as Q90) of no more than 20, 19, 18, 16, 14, 12, 10, 9, 8, 7, 6, 5, 4, 3, 2, 1.9, 1.8, 1.7, 1.6, 1.5, 1.4, 1.3, 1.2, 1.1 or 1% of the coffee product. In some embodiments the amount of fines is between 0-20%, 0-15%, 0-10%, 0-5%, 0-4%, 0-3%, 0-2%, 0-1.9%, 0-1.8%, 0-1.7%, 0-1.6%, 0-1.5%, 0.1-5%, 0.1-4.9%, 0.1-4.8%, 0.1-4.7%, 0.1-4.6%, 0.1-4.5%, 0.1-4.4%, 0.1-4.3%, 0.1-4.2%, 0.1-4.1%, 0.1-4%, 0.1-3.9%, 0.1-3.8%, 0.1-3.7%, 0.1-3.6%, 0.1-3.5%, 0.1-3.4%, 0.1-3.3%, 0.1-3.2%, 0.1-3.1%, 0.1-3%, 0.1-2.9%, 0.1-2.8%, 0.1-2.7%, 0.1-2.6%, 0.1-2.5%, 0.1-2.4%, 0.1-2.3%, 0.1-2.2%, 0.1-2.1%, 0.1-2%, 0.1-1.9%, 0.1-1.8%, 0.1-1.7%, 0.1-1.6%, or from 0.1-1.5%. The fines may be measured, for example, by laser diffraction particle size measurement (e.g. Helos/KR (Sympatec) system measured with R7 lens).

Embodiments with such levels of fines have the particular advantage of improved solubility over coffee products with alternative levels of fines. Moreover, the low level of fines prevents blocking of a coffee container.

According to a second aspect of the invention, there is provided a process for manufacturing a coffee product comprising the steps of:
a) filling a mixing device to 10-90% of its total volume with roast and ground coffee particles.
b) spraying a liquid instant coffee onto the roast and ground coffee particles to coat the roast and ground coffee particles with instant coffee;
c) mixing the mixture formed in step b);
d) densifying the coated roast and ground coffee particles; and
e) drying the coated roast and ground coffee particles to form a coffee product comprising roast and ground coffee particles coated with instant coffee particles.

In some embodiments, the step of filling the mixing device may comprise filling the mixing device to 20-80%, 30-70%, 40-70%, 45-70%, 45-65%, 45-60%, 45-55%, 50-60%, 45-60%, 46-60%, 47-60%, 48-60%, 49-60%, 50-60%, 51-60%, 52-60%, 53-60%, 54-60%, 54-60%, 50-59%, 50-58%, 50-57%, 50-56%, or 50-55% of its total volume.

The inventors discovered that if the mixing device is not filled to its total volume, the step of densifying the coated roast and ground coffee particles may result in fluidised particle motion. This may result in the formation of a mechanically induced fluidised bed.

Beneficially, the partial filling of the mixing device allows improved control of the density of the final product. For example, partial filling of the mixing device may provide a lower density product, whereas the complete filling of the mixing device may provide a higher density product.

Therefore, the step d) of densifying the one or more coated roast and ground coffee particles may comprise mechanically fluidising a bed of the one or more coated roast and ground coffee particles. Preferably, the mixing device is a high shear granulator.

All of the further parameter ranges and features as described in the second aspect of the invention may be as described in the preferred ranges, features and limits of the parameters described for the first aspect of the invention.

According to a third aspect of the invention, there is provided a process for manufacturing a coffee product comprising the steps of:
comprising the steps of:
a) filling a mixing device to 10-90% of its total volume with roast and ground coffee particles;
b) spraying a liquid instant coffee onto the roast and ground coffee particles to coat the roast and ground coffee particles with instant coffee;
c) mixing the mixture formed in step b);
d) densifying the coated roast and ground coffee particles; and
e) drying the coated roast and ground coffee particles to form a coffee product comprising roast and ground coffee particles coated with instant coffee;
   wherein the step of densifying the one or more coated roast and ground coffee particles further comprises mechanically fluidising a bed of the one or more roast and ground coffee particles.

Preferably, the mixing device is a high shear granulator.

All of the further parameter ranges and features as described in the third aspect of the invention may be as described in the preferred ranges, features and limits of the parameters described for the first aspect of the invention.

According to a fourth aspect there is provided a coffee product prepared by a process according to any one of the first to third aspects of the present invention.

The statements relating to the product in the first, second and third aspects of the present invention also apply to the product described in the fourth aspect of the present invention.

According to a fifth aspect of the invention, there is provided a container comprising the coffee product of the fourth aspect of the invention.

The container is preferably a coffee preparation machine insertable container.

In some embodiments, the coffee preparation machine insertable container is selected from: a capsule, a disc, a pod, a pad, a semi-rigid pad, a filter bag, a pouch, a cartridge.

In preferred embodiments, the container has a volume of at least 5 ml, 10 ml, 25 ml, 50 ml, 75 ml, 100 ml, 150 ml, 175 ml, 200 ml, 225 ml, 250 ml, 275 ml, 300 ml, or at least 325 ml. Preferably, the container has a volume of between 50-350 ml. In more preferred, embodiments, the container comprises a coffee preparation machine-readable portion.

Embodiments with such container volumes have the additional advantages of compatibility with beverage preparation machines, such as coffee machines.

In some embodiments, the coffee product occupies at least 45%, 50%, 55%, 60%, 65%, 70%, 75% or 80% and/or no more than 95% or 90% of the total volume of the container. In some preferred embodiments the coffee product occupies between 45%-95%, or between 55%-95%, or between 65%-95%, or between 75%-95%, or between 45%-90%, or between 55%-90%, or between 65%-90% or between 75%-90% of the total volume of the container.

The preferred ranges of the density and median particle size described above for the first aspect of the invention enable significant volume of filling, whilst also preventing blocking of the container. This allows the container to provide a higher amount of total dissolved solids in the resulting brewed coffee.

According to a sixth aspect of the invention there is provided a method of preparing a container of a fifth aspect of the invention comprising steps of:
a) providing a coffee product produced according to the first, second or third aspect of the present invention; and
b) adding the coffee product to a container according to the fifth aspect of the present invention.

In some embodiments, the container is subsequently sealed, preferably by heat sealing. A heat-sealed closure has the particular advantage of being readily pierced in order to extract the contents of the container in conjunction with a beverage preparation machine.

According to a seventh aspect of the invention, there is provided a method of preparing a beverage comprising the steps of;
a) providing a container of the sixth aspect of the invention;
b) transporting fluid through the container; and
c) dissolving and/or suspending at least some of the coffee product in the fluid such that fluid exiting the container comprises at least a portion of the coffee product extracted, dissolved and/or suspended therein.

Preferably, the beverage is a brewed coffee.

In some embodiments, the volume of fluid transport in step b) is at least 10 ml, 25 ml, 50 ml, 75 ml, 100 ml, 150 ml, 175 ml, 200 ml, 225 ml, 250 ml, 275 ml, 300 ml, or at least 325 ml.

The volume of fluid transport in step b) may, for example be between 50 ml-350 ml.

In some embodiments, the fluid transported in step b) is transported under a pressure of less than 25 bar, 22 bar, 20 bar, or 18 bar. In some embodiments, the fluid is transported in step b) under a pressure of at least 0.5 bar, 1 bar, 2 bar, 3 bar, 4 bar, 5 bar, 6 bar, 7, bar, 8 bar, 9 bar, 10 bar, 12 bar, 14 bar, 16 bar or 18 bar. Preferably, the fluid is transported at a pressure of 18 bar.

The time taken for steps b) to c) may be less than 300 seconds, less than 275 seconds, less than, 250 seconds, less than 225 seconds, less than 200 seconds, less than 190 seconds, less than 180 seconds, less than 175 seconds, less than 170 seconds, less than 165 seconds, less than 160 seconds, less than 155 seconds, less than 150 seconds, less than 145 seconds, less than 140 seconds, less than 135 seconds, less than 130 seconds, less than 125 seconds, less than 120 seconds, less than 115 seconds, less than 110 seconds, less than 105 seconds, less than 100 seconds, less than 95 seconds, less than 90 seconds, less than 85 seconds, less than 80 seconds, less than 75 seconds, less than 70 seconds, less than 65 seconds, less than 60 seconds, less than 55 seconds, less than 50 seconds, less than 45 seconds, less than 40 seconds, less than 35 seconds, less than 30 seconds, or less than 25 seconds.

The beverage may have a total dissolved solids amount of at least 0.5%, 0.6%, 0.7%, 0.8%, 0.9%, 1%, 1.1%, 1.2%, 1.3%, 1.4% or at least 1.5%.

Preferably, the beverage may have an amount of total dissolved solids of 1.0-5.0%, 1-4.5%, 1-4.0%, 1-3.5%, 1-3%, 1-2.5%, 1-2%, 1.0-1.7, 1.1-1.7, 1.0-1.5%, 1.0-1.4%, 1.1-1.4%, 1.2-1.7%, 1.3-1.6%, or 1.4-1.5%

According to an eighth aspect of the invention, there is provided a coffee product produced according to the first, second or third aspect of the present invention for use in a beverage preparation machine.

Preferably, the beverage preparation machine is a coffee preparation machine.

The further aspects of the present invention may incorporate any of the features of the other aspects of the invention described herein as desired or as appropriate.

### DETAILED DESCRIPTION OF THE INVENTION

In order that the invention may be more clearly understood one or more embodiments thereof will now be described, by way of example only, with reference to the accompanying drawings, of which:

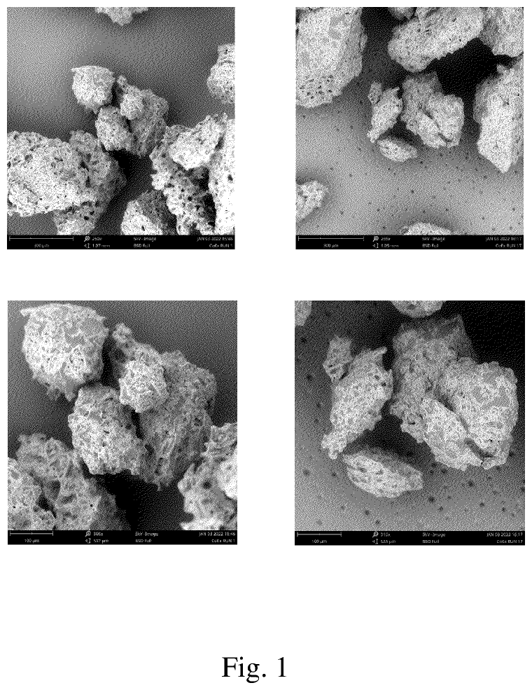

FIG. 1 shows a Scanning electron microscope (SEM) image 250× magnification (top) and 500× magnification (bottom) of a coffee product produced according to Example 1 (left) and Example 2 (right)

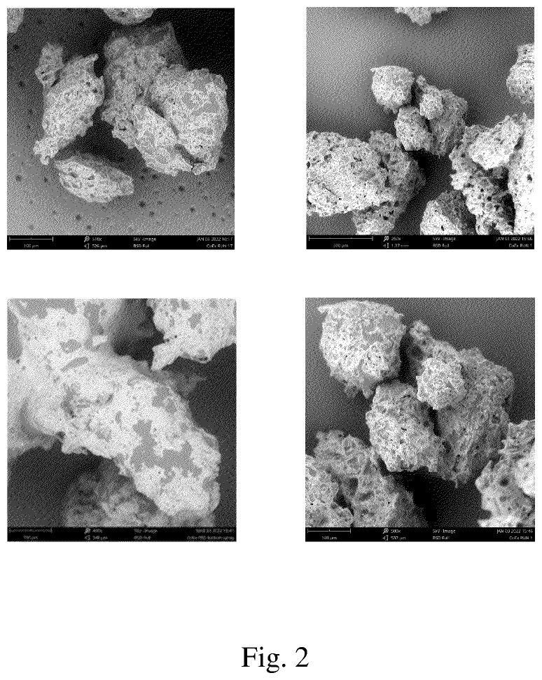

FIG. 2 shows an SEM image 250× magnification (top) and 500× magnification (bottom) of a coffee product produced according to Reference Example 6 (left) and Example 1 (right)

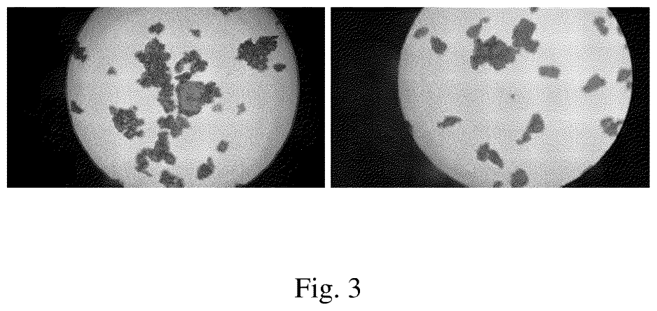

FIG. 3 shows a microscope image of a coffee product produced according to Reference Example 6 (left) and Example 1 (right).

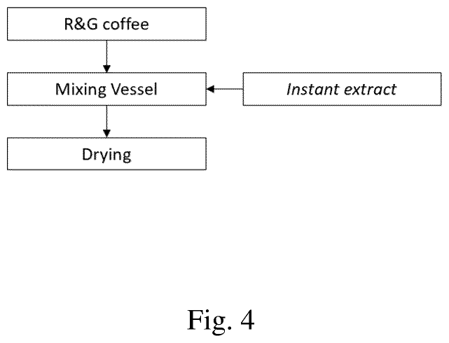

FIG. 4 shows a process scheme according to the present invention.

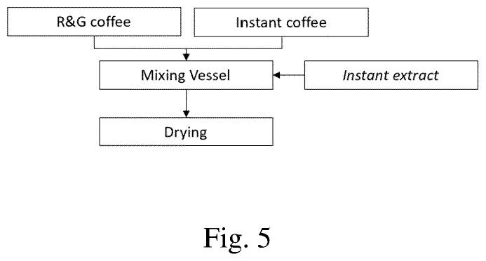

FIG. 5 shows a process scheme according to the present invention.

### EXAMPLES

Coffee products were prepared according to the first aspect of the present invention as set out below.

### Example 1

Roast and ground coffee particles were placed inside a Lödige L5 granulator operating at a spray pressure of 5 bar and a tip speed of 2 m/s. The roast and ground coffee particles had a median particle size of 400 μm and bulk density of 280 g/l. The roast and ground coffee particles were then sprayed with liquid instant coffee in amount of 20 wt. % by weight of the coffee product and the resulting mixture was mixed for a total time of 590 s to coat the roast and ground coffee particles with instant coffee. The spraying of liquid instant coffee and shear created by the mixing impeller of the granulator, resulted in densified roast and ground coffee particles coated by instant coffee. The coated roast and ground coffee particles were then dried using a Neuhaus Neotec LFB mini L dryer to form a coffee product of the present invention.

The coffee product of Example 1 had a median particle size of 457 μm, a bulk density of 402 g/l and comprised roast and ground coffee in an amount of 80 wt. % by weight of the coffee product and instant coffee in an amount of 20 wt. % of the coffee product. As shown in FIG. 1, the coffee product did not possess significant fines and the roast and ground coffee was coated by a uniform layer of instant coffee. Moreover, the product exhibited less friable and more dense agglomerates when compared to a coffee product prepared using a fluidised bed dryer (see Reference Example 5) as shown in FIG. 3.

11.7 g of the coffee product of Example 1 was then loaded into a capsule and brewed using a L'Or Barista capsule system. The machine provides water heated to between 85 and 95° C. and a target drink volume of 340 ml. The coffee product successfully brewed without blocking the capsule in a time of under 180 seconds and the resulting brewed coffee had a total dissolved solids amount of 1.28%. The brewed coffee had an overall roast and ground coffee taste.

### Example 2

A dry mixture of roast and ground coffee particles were placed inside a Lödige L5 granulator operating at a spray pressure of 5 bar and a tip speed of 2 m/s. The roast and ground coffee particles had a median particle size of 400 μm and bulk density of 350 g/l. The dry mixture comprised roast and ground coffee particles in an amount of 92 wt. % by weight of the mixture and solid instant coffee particles in an amount of 8 wt. % by weight of the mixture. The mixture was then sprayed with liquid instant coffee in amount of 7.5 wt. % by weight of the final coffee product and the resulting mixture was mixed for a total time of 640 seconds to coat the roast and ground coffee particles with instant coffee. The spraying of liquid instant coffee and shear created by the mixing impeller of the granulator, resulted in densified roast and ground coffee particles coated by instant coffee. The coated roast and ground coffee particles were then dried using a Neuhaus Neotec LFB mini L dryer to form a coffee product of the present invention.

The coffee product of Example 2 had a median particle size of 436 μm, a bulk density of 413 g/l and comprised roast and ground coffee in an amount of 85 wt. % by weight of the coffee product and instant coffee in an amount of 15 wt. %. by weight of the coffee product. As shown in FIG. 1, the coffee product did not possess significant fines and the roast and ground coffee was coated by a uniform layer of instant coffee.

13.1 g of the coffee product of Example 2 was then loaded into a capsule and brewed using a L'Or Barista capsule system. The machine provides water heated to between 85 and 95° C. and a target drink volume of 340 ml. The coffee product successfully brewed without blocking the capsule in a time of under 180 seconds and the resulting brewed coffee had a total dissolved solids amount of 1.23%. The brewed coffee had an overall roast and ground coffee taste.

### Example 3

Roast and ground coffee particles were placed inside a Lödige L5 granulator operating at a spray pressure of 5 bar, and a tip speed of 2 m/s. The high shear granulator was only filled to 60% of its total volume. The roast and ground coffee particles had a median particle size of 400 μm and bulk density of 350 g/l. The roast and ground coffee particles were then sprayed with liquid instant coffee in amount of 20 wt. % by weight of the coffee product and the resulting mixture was mixed for a total time of 640 seconds to coat the roast and ground coffee particles with instant coffee. The spraying of liquid instant coffee and shear created by the mixing impeller of the granulator, resulted in densified roast and ground coffee particles coated by instant coffee. During mixing, a mechanically induced fluidised bed was created.

The coffee product of Example 3 had a median particle size of 436 μm, a bulk density of 413 g/l and comprised roast and ground coffee in an amount of 80 wt. % by weight of the coffee product and instant coffee in an amount of 20 wt. % by weight of the coffee product.

13.1 g of the coffee product of Example 3 was then loaded into a capsule and brewed using a L'Or Barista capsule system. The machine provides water heated to between 85 and 95° C. and a target drink volume of 340 ml. The coffee product successfully brewed without blocking the capsule in a time of under 180 seconds and the resulting brewed coffee had a total dissolved solids amount of 1.23%. The brewed coffee had an overall roast and ground coffee taste.

### Example 4

Roast and ground coffee particles were placed inside a Lödige L5 granulator operating at a spray pressure of 5 bar, and a tip speed of 2 m/s. The roast and ground coffee particles were then sprayed with liquid instant coffee in amount of 20 wt. % by weight of the coffee product and the resulting mixture was mixed for a total time of 640 seconds to coat the roast and ground coffee particles with instant coffee. The spraying of liquid instant coffee and shear created by the mixing impeller of the granulator, resulted in densified roast and ground coffee particles coated by instant coffee.

The coffee product of Example 4 had a median particle size of 450 μm, a bulk density of 350 g/l and comprised roast and ground coffee in an amount of 80 wt. % by weight of the coffee product and instant coffee in an amount of 20 wt. % by weight of the coffee product.

9 g of the coffee product of Example 4 was then packed into a Senseo filter pad of compostable paper and brewed using a Senseo Original beverage preparation machine and pad holder. The machine provides water heated to between 85 and 95° C. and a target drink volume of 120 ml. The coffee product successfully brewed without blocking the capsule and the resulting brewed coffee had a total dissolved solids amount of 1.3%. The brewed coffee had an overall roast and ground coffee taste.

### Reference Example 5

A dry mixture of roast and ground coffee particles were placed inside a high shear granulator operating at a spray pressure of 5 bar, and a tip speed of 2 m/s. The mixture comprised roast and ground coffee particles in an amount of 80 wt. % by weight of the mixture and solid instant coffee in an amount of 20 wt. % by weight of the mixture. The roast and ground coffee particles were then sprayed with water and mixed for a total time of 440 seconds to coat the roast and ground coffee particles with instant coffee. The spraying of water and shear created by the mixing impeller of the granulator, resulted in densified roast and ground coffee particles coated by instant coffee.

The coffee product of Reference Example 5 had a median particle size of 455 μm, density of 453 g/l and comprised roast and ground coffee in an amount of 80 wt. % by weight of the coffee product and instant coffee in an amount of 20 wt. % by weight of the coffee product. The coffee product did not possess significant fines but the roast and ground coffee particles were not coated with a uniform layer of instant coffee. Instead, the instant coffee could be seen to coat the roast and ground coffee in patches.

12.7 g of the coffee product of Reference Example 5 was then loaded into a capsule and brewed using a L'Or Barista capsule system. The machine provides water heated to between 85 and 95° C. and a target drink volume of 340 ml. The coffee product did not successfully brew and resulted in blocking of the capsule.

### Reference Example 6

Roast and ground coffee particles were placed inside a fluidised bed dryer operating at an air flow of 130 m³/h at 80° C., till moisture content was below 5%. The roast and ground coffee particles were sprayed with liquid instant coffee in a concentration of 40% in amount of 20 wt. % by weight of the final coffee product and the resulting mixture was mixed to coat the roast and ground coffee particles with instant coffee. The mixture was simultaneously sprayed and dried to form a coffee product.

The coffee product of Reference Example 6 had a median particle size of 581 μm and a density of 378 g/l and comprised roast and ground coffee in an amount of 80 wt. % by weight of the coffee product and instant coffee in an amount of 20 wt. % by weight of the coffee product.

12 g of the coffee product of Reference Example 6 was then loaded into a capsule and brewed using a L'Or Barista capsule system. The machine provides water heated to between 85 and 95° C. and a target drink volume of 340 ml. The coffee product did not successfully brew and resulted in blocking of the capsule.

As shown in FIGS. 2 and 3, the coffee product produced using a fluidised bed dryer had a lower density than those produced in a high shear granulator. This is thought to mean that the agglomerates are less tightly bound together allowing them to break apart more easily, migrate and block water channels in the capsule bed, thereby blocking the capsule.

### Reference Example 7

11.3 g of roasted and ground coffee alone was loaded into a capsule and brewed using a L'Or Barista capsule system The resulting brewed coffee had a total dissolved solids amount of 0.9% at a drink volume of 340 ml. This resulted in a dilute coffee with insufficient amount of total dissolved solids for the taste of some consumers.

### Reference Example 8

11.3 g of instant coffee was loaded into a capsule and brewed using a L'Or Barista capsule system. The resulting brewed coffee had a total dissolved solids amount of 2% at a drink volume of 340 ml. However, the resulting brewed coffee had a distinctive instant coffee flavour.

The one or more embodiments are described above by way of example only. Many variations are possible without departing from the scope of protection afforded by the appended claims.

1. A process for manufacturing a coffee product comprising the steps of:
a) spraying a liquid instant coffee onto roast and ground coffee particles to coat the roast and ground coffee particles with instant coffee;
b) mixing the mixture formed in step a);
c) densifying the coated roast and ground coffee particles; and
d) drying the coated roast and ground coffee particles to form a coffee product comprising roast and ground coffee particles coated with instant coffee.

2. A process according to claim 1, wherein the step of spraying the liquid instant coffee comprises spraying liquid instant coffee in an amount of from 1-20 wt. %, 1-15 wt. %, 1-10 wt. %, 1-9 wt. %, 1-8 wt. %, 1-6 wt. %, 1-7 wt. %, 1-6 wt. %, or from 1-5 wt. % by weight of the coffee product.

3. A process according to claim 1, wherein the coffee product comprises roast and ground coffee in an amount of from 70-99 wt. %, 80-99 wt. %, 75-99 wt. %, 75-99 wt. %, 80-99 wt. %, 85-99 wt. %, 90-99 wt. %, 80-95 wt. %, 80-95 wt. %, or 80-95 wt. % by weight of the coffee product.

4. A process according to claim 1, wherein the step of densifying the coated roast and ground coffee particles comprises increasing the density of the coated roast and ground coffee particles to at least 250, 300, 350 g/l or 400 g/l and/or no more than 850, 650 or 600 g/l and/or between 250-850 g/l; 35-850 g/l; 250-600 g/l or 350-600 g/l.

5. A process according to claim 1, wherein the step of densifying the coated roast and ground coffee particles comprises subjecting the roast and ground coffee particles to shear mixing.

6. A process according to any claim 1, wherein the process further comprises a step of filling a mixing device with one or more roast and ground coffee particles and wherein the step of filling the mixing device is before step a).

7. A process according to claim 6, wherein the step of filling the mixing device comprises filling the mixing device to 40-70% or 50-60% of its total volume.

8. A process according to claim 7, wherein the step c) of densifying the coated roast and ground coffee particles comprises mechanically fluidising a bed of the coated roast and ground coffee particles.

9. A process according to claim 6, wherein the mixing device is a granulator.

10. A process according to claim 1, wherein the process further comprises the step of spraying a binding liquid onto the roast and ground coffee particles and wherein the binding liquid is an aqueous medium, such as a sugar solution or water.

11. A process according to claim 1, wherein the roast and ground coffee particles in step a) comprise a dry mixture of solid instant coffee particles and roast and ground coffee particles.

12. A process according to claim 11, wherein the dry mixture comprises solid instant coffee particles in an amount of 1-30 wt. %, 1-25 wt. %, 1-20 wt. %, 5-30 wt. %, 5-25 wt. %, or 5-20 wt. % by weight of the mixture.

13. A process according to claim 1, wherein the mixture formed in step a) is mixed in step b) for a period at least 50 seconds.

14. A process for manufacturing a coffee product comprising the steps of:
a) filling a mixing device to 10-90% of its total volume with roast and ground coffee particles;
b) spraying a liquid instant coffee onto roast and ground coffee particles to coat the roast and ground coffee particles with instant coffee;
c) mixing the mixture formed in step b);
d) densifying the coated roast and ground coffee particles; and
e) drying the coated roast and ground coffee particles to form a coffee product comprising roast and ground coffee particles coated with instant coffee.

15. A process for manufacturing a coffee product comprising the steps of:
a) filling a mixing device to 10-90% of its total volume with roast and ground coffee particles.
b) spraying a liquid instant coffee onto roast and ground coffee particles to coat the roast and ground coffee particles with instant coffee;
c) mixing the mixture formed in step b);
d) densifying the coated roast and ground coffee particles; and
e) drying the coated roast and ground coffee particles to form a coffee product comprising roast and ground coffee particles coated with instant coffee;
wherein the step of densifying the coated roast and ground coffee particles further comprises mechanically fluidising a bed of the roast and ground coffee particles.

16. A coffee product prepared by a process according to claim 1, wherein the coffee product comprises roast and ground coffee particles coated with instant coffee.

17. A coffee product according to claim 16, wherein at least 50% of the surface of the roast and ground coffee particles is covered with instant coffee.

18. A coffee product according to claim 16, wherein the median particle size of the coffee product is between 200 and 1000 microns.

19. A coffee product according to claim 16, wherein the coffee product has an amount of fine particles less than 90 microns of between 0-20%, preferably between 0-15%, more preferably between 0-10%, and most preferably between 0-5%.

20. A container comprising the coffee product of claim 16.

21. A container according to claim 20, wherein the container is a capsule.

22. A method of preparing a container comprising steps of:
a) providing a coffee product produced according to claim 1; and
b) adding the coffee product to the container.

23. A method of preparing a beverage comprising the steps of;
a) providing a container according to claim 20;
b) transporting fluid through the container; and
c) dissolving and/or suspending at least some of the coffee product in the fluid such that fluid exiting the container comprises at least a portion of the coffee product extracted, dissolved and/or suspended therein.

24. A method according to claim 23, wherein the volume of fluid transport in step b) is between 50 ml-350 ml.

25. A method according to claim 23, wherein the fluid is transported at a pressure of at least 1 bar.

26. A method according to claim 23, wherein the time taken for steps b) to c) is less than 200 seconds, less than 180 seconds, less than 60 seconds, or less than 25 seconds.

27. A method according to claim 23, wherein the beverage may have a total dissolved solids amount of at least 1%, 1.1%, or 1.2%,

28. A coffee product according to claim 16, for use in a beverage preparation machine.
